(19) United States
(12) Patent Application Publication
(10) Pub. No.: US 2009/0249392 A1
(43) Pub. Date: Oct. 1, 2009

(54) DIGITAL BROADCAST RECEIVER AND METHOD FOR PROCESSING CAPTION THEREOF

(75) Inventor: Tae Jin Park, Gyeonggi-do (JP)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/058,348

(22) Filed: Mar. 28, 2008

(51) Int. Cl. H04N 5/445; H04N 7/173

(52) U.S. Cl. 725/38; 725/131

(57) ABSTRACT

A digital cable broadcast receiver and a method for automatically processing caption data of various standards and types, is disclosed. The digital broadcast receiver receives caption information indicating whether an digital television closed caption service is present or a line 21 closed caption service is present in the video stream. And the digital broadcast receiver receives also detailed caption service information indicating what kind of analog caption service is provided by decoding the analog caption data. Accordingly, the broadcast receiver can provide a user with information on what kind of analog caption service by decoded caption data can be provided.

### BACKGROUND OF THE INVENTION

1. Field of the Invention

The present invention relates to a digital cable broadcast receiver, and more particularly, to a digital cable broadcast receiver and a method for processing a caption thereof that can process a caption of a various types and standards for use in a digital cable broadcast, in an adaptive manner.

2. Discussion of the Related Art

A ground wave broadcast standard for an analog broadcast in USA (United States of America) is an NTSC (national television system committee) standard. The NTSC standard is characterized in transmitting a closed caption such as English, Spanish, using a 21^{st} line of a VBI (vertical blanking interval) of a broadcast signal. A standard related to the transmission of the closed caption is an EIA (electronic industry association) standard 608. Services provided through a 21^{st} line of the VBI under the EIA 608 standard are as follows: CC1 (primary synchronous caption service), CC2 (special asynchronous caption service), CC3 (secondary synchronous caption service), CC4 (special asynchronous caption service), Text1 (first letter information service), Text2 (second letter information service) Text3 (third letter information service), Text4 (fourth letter information service).

In USA, a user has to select, in person, one among the above-mentioned services. Further, since there is no information as to which service is provided among the above-mentioned eight services while a broadcast program is displayed, there has been a difficulty that a user should check, case by case, the services so as to check a service under execution.

A ground wave broadcast standard for a digital broadcast in USA is an ATSC (advanced television system committee) standard. Further, an EIA 708, which is a standard on a digital TV closed caption (DTVCC), is established. The DTVCC will be described with reference to the accompanying drawings. FIG. 1 illustrates the general bit stream provided to a digital TV. As shown in FIG. 1, the bit stream includes: audio data, video data, control data (i.e., supplementary information). Data that corresponds to the DTVCC is included in user_data bits of the video data and transmitted under an MPEG-2 (Moving Picture Experts Group-2) video standard and the ATSC standard (A53). At this point, according to the above standards, the DTVCC data can be transmitted up to as much as 128 bytes at its maximum for each user_data region and the total transmission amount cannot exceed 9600 bps (bit per second). Compared with an analog closed caption based on the EIA 608, where the total transmission amount cannot exceed 960 bps, the DTVCC based on the EIA 708 has realized ten times greater bandwidth in its data transmission. The DTVCC based on the EIA 708 can provide sixty-three caption services in total with consideration of the extended bandwidth. In case of the sixty-three digital caption services, there is a difficulty that a user should change settings to find out a desired caption service as was done in the above-described analog closed caption. Due to such reason, in case of providing a DTVCC according to the ATSC standard, a broadcast station must include information called a caption_service_descriptor within an EIT (event information table) or a PMT (program map table) in a PSIP (program and system information protocol). The EIT and the caption_service_descriptor allow a DTV receiver to know what kind of the DTVCC is included in a relevant program.

The cable broadcast is a little different from the ground wave broadcast depending on regions, or service companies, or broadcast equipments. In particular, the cable broadcast is the same as the ground wave analog broadcast in that transmission is performed on the basis of a letter value and a command set prescribed by the EIA 608 in operating a closed caption. However, the cable broadcast is different from the ground wave broadcast in transmitting the closed caption using other interval of the VBI except a 21^{st} line of the VBI. That is, some broadcast station transmits a caption using a sixth line of the VBI while other broadcast station transmits a caption using a tenth line. In the meantime, as an analog cable broadcast is switched into a digital cable broadcast, a closed caption standard regarding the digital broadcast has been established independently. The basic object of standards tilted SCTE (society of cable television engineers) 20 and DVS (digital video surveillance) 157 is to convert an analog closed caption for use in the analog cable broadcast into user_data within a video data region for use in a digital TV. Those standards do not include content regarding a DTVCC of the EIA 708 standard but only prescribe content regarding the analog closed caption as is done in the existing standards.

The ATSC standard regarding the DTVCC does not consider the closed caption under the SCTE 20 or the DVS 157 which are caption transmission standards for use in the cable broadcast. Since a cable broadcast service company has provided a cable set top box appropriate for the company's broadcast to each user, there was little problem in a digital-cable-broadcast generation before an open-cable generation. However, under a new digital broadcast environment such as an open cable and a Cable Ready, there occur problems regarding the standards. That is, under the open cable and the Cable Ready environments whose object is to connect an apparatus generally available in the market, not a specific cable broadcast receiver provided by a specific cable broadcast company, to a cable, a method for transmitting/receiving a caption emerges as a very complicated problem.

An open cable broadcast signal under regulations of a FCC (federal communications commission) must include a DTVCC and an analog CC (closed caption) prescribed by the EIA 708. Further, the open cable broadcast signal should include user_data of other type prescribed by the SCTE 20 or the DVS 157 and may include a relevant caption at a S-Video, a Composite, a 480i, and a VBI line of the Component output. Therefore, the cable broadcast receiver should know what kind of caption data is included in a digital cable broadcast being received. However, it is difficult for the cable broadcast receiver to judge a kind of caption data being received in view of characteristics of caption data. Accordingly, a user should check in person the caption data through a key or a menu on a remote control. Also, a user should experimentally select and check what kind of caption data is decoded.

### SUMMARY OF THE INVENTION

Accordingly, the present invention is directed to a digital cable broadcast receiver and a method for processing a caption thereof that substantially obviate one or more problems due to limitations and disadvantages of the related art.

An object of the present invention is to provide a digital cable broadcast receiver and a method for processing a caption thereof that can automatically process caption data of various standards and types.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a digital cable broadcast receiver including: a demultiplexer for dividing a received broadcast stream into video data, audio data, supplementary information; a controller for judging whether caption data included in the video data is digital caption data or analog caption data on the basis of caption information included in the supplementary information, and outputting a control signal according to a result of the judgment; a digital caption decoder for extracting and decoding digital caption data from the video data according to the control signal; and an analog caption decoder for extracting and decoding analog caption data from the video data according to the control signal.

The controller judges a number of caption services, a national language, a difficulty level of a caption, a line number and a field of a VBI that corresponds to the caption data, a picture ratio, provided by the caption data included in the video data, on the basis of the caption information.

If the caption data included in the video data is digital caption data, the controller detects a caption service number that corresponds to the caption data from the caption information and transmits the control signal including the detected caption service number to the digital caption decoder.

If the caption data included in the video data is analog caption data, the controller judges the caption data's standard on the basis of the caption information. If the caption data is an analog caption data of an EIA 708, the controller detects field information that corresponds to the caption data from the caption information, and transmits the control signal including the detected field information to the analog caption decoder, and if the caption data is an analog caption data of the SCTE 20 or the DVS 157 standards, the controller detects field information and VBI line information that correspond to the caption data and transmits the control signal including the detected field information and the VBI line information, to the analog caption decoder.

In another aspect of the present invention, a digital broadcast receiver further includes: a program map table (PMT) buffer for storing a PMT included in the supplementary information and transmitting the stored PMT to the controller; an event information table (EIT) buffer for storing an EIT included in the supplementary information and transmitting the stored EIT to the controller; and a graphic block for receiving characteristic information of the caption data detected from the supplementary information, from the controller and displaying characteristics of the caption data on a screen.

In still another aspect of the present invention, a method for processing caption includes the steps of: dividing a received broadcast stream into video data, audio data, and supplementary information; judging whether caption data included in the video data is digital caption data or analog caption data on the basis of caption information included in the supplementary information; and selectively detecting at least one of parameters included in the caption information according to a result of the judgment; and extracting and decoding the caption data included in the video data on the basis of the detected parameter.

The step of selectively detecting at least one of parameters included in the caption information according to the result of the judgment, includes the step of: if the caption data included in the video data is digital caption data, detecting a caption service number that corresponds to the caption data from the caption information.

The step of selectively detecting at least one of parameters included in the caption information according to the result of the judgment, includes the step of: if the caption data included in the video data is analog caption data, detecting a standard of the caption data on the basis of the caption information; and detecting at least one of parameters included in the caption information according to the detected standard. At this point, if the detected standard of the caption data is the EIA 708, a field value that corresponds to the caption data is detected from the caption information and if the detected standard of the caption data is the SCTE 20 or the DVS 157, a field value and a VBI line number that correspond to the caption data are detected from the caption information.

The method for processing caption further includes the steps of: detecting characteristics of the caption data included in the video data on the basis of the caption information; and displaying the detected characteristics on a screen.

The characteristics of the caption data includes at least one among a number of caption services, a national language of a caption, a difficulty level of a caption, a picture ratio of a caption, a field value and a VBI line number that correspond to the caption data, provided by the caption data.

Another aspect of the present invention, a digital broadcast receiver may include a demultiplexer, a controller, a video decoder, a digital caption decoder and an analog caption decoder. The demultiplexer demupltiplexes received broadcasting signals into supplementary information stream including Event information table (EIT), audio stream and video stream and the controller detects caption information and detailed caption service information from the EIT. The video decoder decodes video data from the video stream and the digital caption decoder decodes digital caption data in the video stream according to the caption information. And the analog caption decoder decodes analog caption data in the video stream according to the caption information and the detailed caption service information. Herein the detailed caption service information indicates what kind of analog caption service is provided by decoding the analog caption data.

Another aspect of the present invention, the method for processing a digital broadcast signal disclosed. First, a broadcast signal into supplementary information stream including Event information table (EIT), audio stream and video stream are demultiplexed. Caption information and detailed caption service information from the EIT are detected and analog caption data in the video stream is decoded according to the caption information and the detailed caption service information. Herein the detailed caption service information indicates what kind of analog caption service is provided by decoding the analog caption data.

The caption information and the detailed caption service information may be included in the Program map table (PMT). The caption information may indicate whether an digital television closed caption service is present in the video stream or an line 21 closed caption service is present.

The detailed caption service information may indicate that analog caption data is at least one of primary synchronous caption service, special asynchronous caption service, first letter information service, second letter information service, secondary synchronous caption service, special asynchronous caption service, third letter information service and fourth letter information service, all of which are regulated under Consumer Electronics Association (CEA)-708.

The detailed caption service information include one bit of first field indicating “field 1” or “field 2” defined in Consumer Electronics Association (CEA)-708, and four bits of second field indicating that what kind of analog caption service is provided according to the first field.

The first bit of the four bits of the second field indicates whether primary synchronous caption service is provided or not, second bit of the four bits indicates whether special asynchronous caption service is provided or not, third bit of the four bits indicates whether first letter information service is provided or not, and fourth bit of the four bits indicates whether second letter information service is provided or not, respectively.

The first bit of the four bits of the second field indicates whether secondary synchronous caption service is provided or not, second bit of the four bits indicates whether special asynchronous caption service is provided or not, third bit of the four bits indicates whether third letter information service is provided or not and fourth bit of the four bits indicates whether fourth letter information service is provided or not, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a bit stream of the general digital broadcast;

FIG. 2 is a view illustrating a syntax of caption information according to the present invention;

FIG. 3 is a block diagram illustrating a construction of a broadcast receiver according to the present invention; and

FIG. 4 is a flowchart illustrating a method for processing a caption according to the present invention.

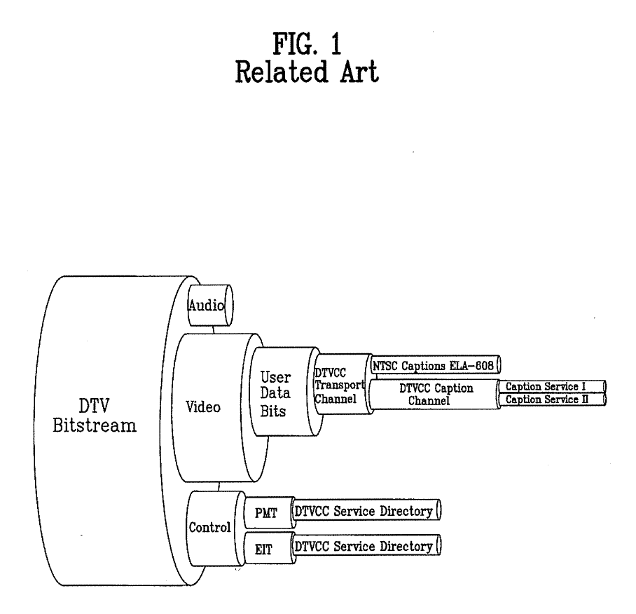

### DETAILED DESCRIPTION OF THE INVENTION

Reference will now be made in detail to the preferred embodiments of the present invention, examples of which are illustrated in the accompanying drawings.

A digital cable broadcast under an open cable and a Cable Ready standards observes an ATSC standard. Therefore, the caption_service_descriptor the EIT or the PMT within the PSIP, included in the digital cable broadcast signal is prescribed by the ATSC standard (A65, Program and System Information Protocol for Terrestrial Broadcast and Cable).

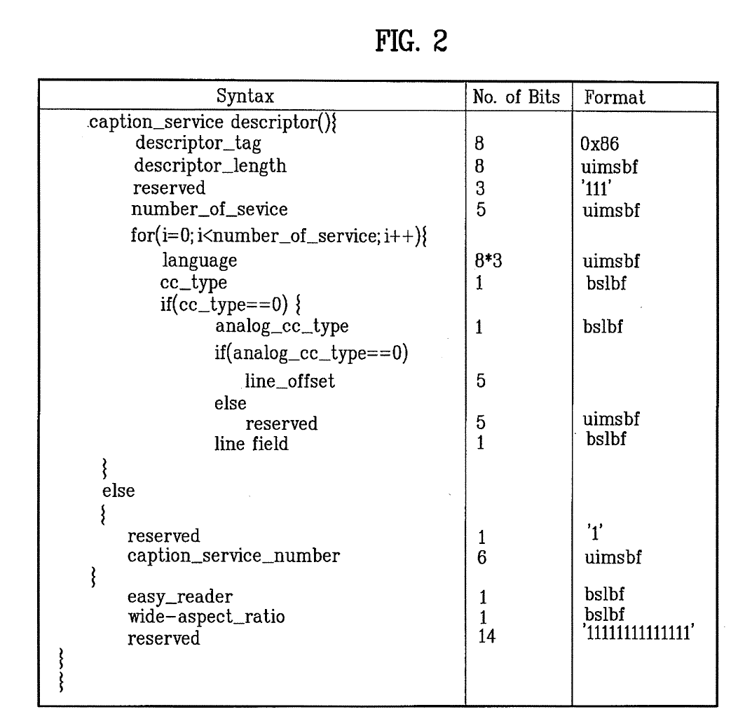

FIG. 2 is a view showing a syntax of the caption_service_descriptor under the open cable and the Cable Ready standards according to the present invention. “descriptor_tag”, which is a parameter for checking a type of a descriptor, is described by 8 bits. “descriptor_length”, which is a parameter representing a length of the whole structure, is described by 8 bits. “number_of_services” represents a number of provided caption services and is described by 5 bits. “language” represents language information of a relevant caption, such as English for a service 1 and Spanish for a service 2, and is a 3-byte language code under ISO 639.2/B, each letter of which is coded with 8 bits and inserted into a 24-bit field. “cc_type” represents a kind of caption. If cc_type==1, it is a digital caption (advanced caption) and if cc_type==0, it is an analog caption (analog caption under the EIA 708 or the SCTE 20 (DVS 157)). The “cc_type” is described by 1 bit. “analog_cc_type” represents a kind of an analog caption. If analog_cc_type==1, it means caption data transmitted through a line 21 of the VBI under the EIA 708, and if analog_cc_type==0, it means caption data transmitted through other line except the line 21 of the VBI according to the SCTE 20 or the DVS 157. “line_offset” represents a number of the VBI line including the caption data in case caption data under the SCTE 20 or the DVS 157 is transmitted, namely, in case the analog_cc_type==0, and is described by 5 bits. “line_field” represents whether the caption data is included in an even field or an odd field. That is, if line_field==0, it means the caption data is included in an odd field and if line_field==1, it means the caption data is included in an even field. “caption_service_number” represents 1-63 caption service numbers in case it is a digital caption, namely, in case cc_type==1. and is described by 6 bits. “easy_reader” is a flag representing whether it is a caption easily read by a user or not. “wide_aspect ratio” is related to a screen ratio, and more particularly, is a flag representing whether a received caption data is intended for a 16:9 screen or not.

If cc_type==0, a received caption is an analog caption. As described above, for the analog caption, there exist an analog caption under the EIA 708 standard, and an analog caption under the SCTE 20 or the DVS 157 standard. However, since the analog caption under the EIA 608 standard is a pure analog caption, not a closed caption for a digital TV mentioned in the present invention, the analog caption under the EIA 608 standard is excluded. Therefore, an analog caption for the case cc_type==0, is either an analog caption under the EIA 708 standard or an analog caption under the SCTE 20 or the DVS 157 standard.

“analog_cc_type” represents whether a received caption is an analog caption under the EIA 708 standard or an analog caption under the SCTE 20 or the DVS 157 standard. If analog_cc_type==0, it means that the relevant caption is included in a video data region in form of user data under the SCTE 20 or the DVS 157, which are standards on the digital cable broadcast. In that case, since to which line of the VBI the received caption is assigned, is not known in view of characteristics of the cable broadcast, the line_offset describes to which line of the VBI the received caption is included. If analog_cc_type==1, it means that an analog caption under the EIA 708 standard is included in a video data region in form of user data. In that case, since the caption is assigned to a 21^{st} line of the VBI, a line_offset value is not required. Therefore, 5 bits assigned to the line_offset becomes a reserved bit and 1 bit is assigned to the line_field representing whether a caption is a caption included in an even field or a caption included in an odd field. If line_field==0, it means a caption is included in an odd field and if line_field==1, it means a caption is included in an even field.

As described above, whether a caption included in the digital cable broadcast is an analog caption or a digital caption is judged on the basis of information included in the caption_service_descriptor. Further, if the received caption is an analog caption, whether the caption is an analog caption under the EIA 708 standard or a caption for a cable broadcast under the SCTE 20 or the DVS 157 standard, is judged. If the received caption is a caption under the SCTE 20 or the DVS 157 standard, in which line of the VBI the caption data is included, is judged. If the received caption is a digital caption, information as to which service the caption includes among sixty-three services, is checked.

A broadcast station generates caption information including the above described various information and adds the caption information to a broadcast signal. A broadcast receiver detects caption information included in a broadcast signal provided from the broadcast station, and judges various characteristics of the received caption data on the basis of parameter values included in the detected caption information.

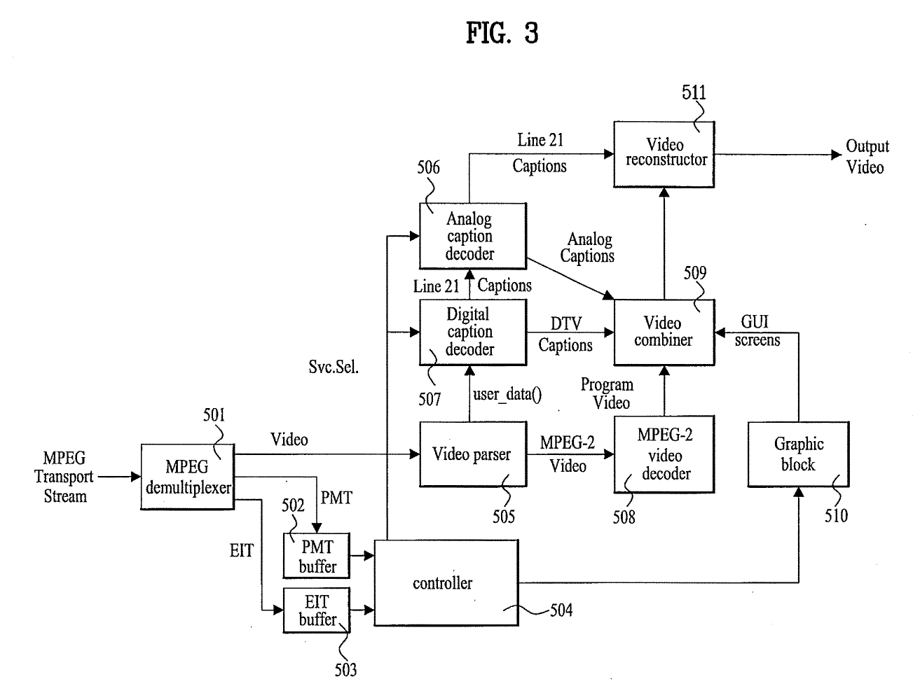

FIG. 3 is a block diagram illustrating a construction of a digital broadcast receiver according to the present invention. Referring to FIG. 3, a MPEG demultiplexer 501 receives a MPEG-2 transport stream from a cable and decodes the transport stream so as to extract video data, audio data, and supplementary information. Further, the MPEG demultiplexer 501 detects an EIT and a PMT included in the supplementary information. The detected PMT is stored in a PMT buffer 502 and the detected EIT is stored in an EIT buffer 503. Here, the detected PMT or EIT includes caption information, namely, a caption_service_descriptor. A controller 504 receives caption information from the PMT buffer 502 or the EIT buffer 503 and detects caption data included in the transport stream on the basis of the caption information. A video parser 505 receives video data decoded by the demultiplexer 501 and separates the video data into user_data and MPEG-2 video data. An analog caption decoder 506 receives user_data from the video parser 505 and detects analog caption data from the user_data on the basis of a signal outputted from the controller 504. A digital caption decoder 507 receives the user_data from the video parser 505 and detects digital caption data from the user_data on the basis of a signal outputted from the controller 504. A MPEG-2 video decoder 508 decodes MPEG-2 video data generated by the video parser 505. A graphic block 510 outputs a signal for generating a GUI (graphic user interface) such as an OSD (on screen display) menu including information provided from the controller 504. The graphic block 510 displays, on a screen, various characteristics of the received caption data, for example, a number of caption services, a national language of a caption, a type and a standard of the received caption data, VBI line information and field information that correspond to the caption data, a difficulty level of the caption, a picture ratio of the caption. A video combiner 509 receives analog caption data from the analog caption decoder 506 or receives digital caption data from the digital caption decoder 507. Further, the video combiner 509 receives video data from the MPEG-2 video decoder 508 and receives a signal outputted from the graphic block 510. The video combiner 509 combines the received signals so as to generate data that will be possibly displayed. A video reconstructor 511 encodes an analog caption data decoded by the analog caption decoder 506, at a 21^{st} line of the VBI.

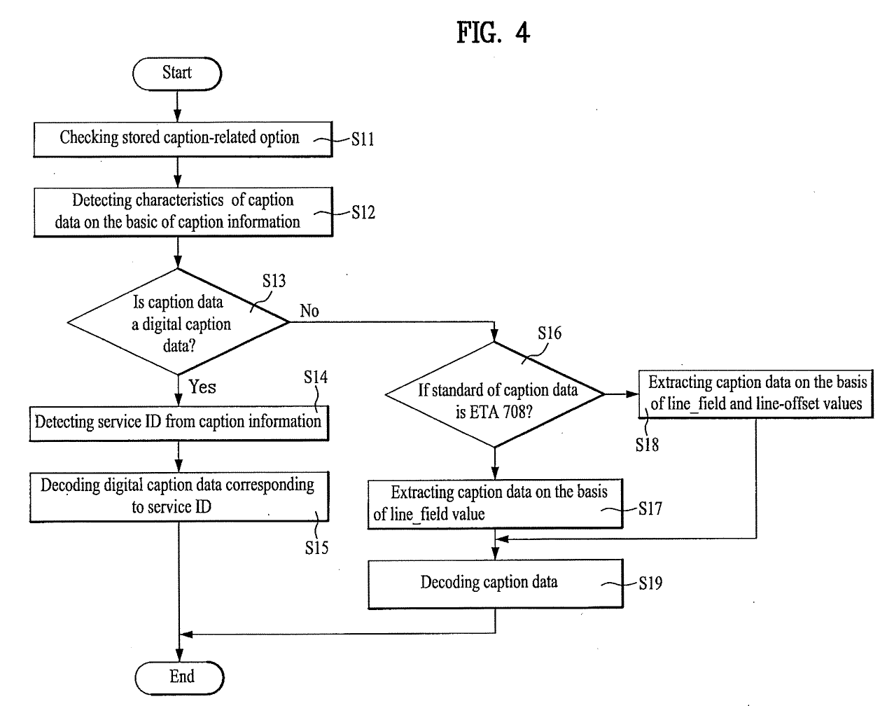

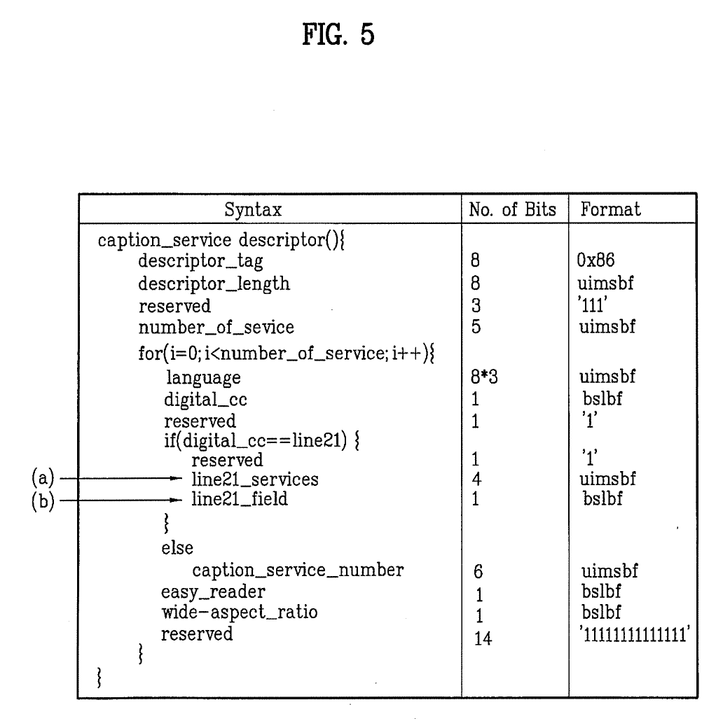

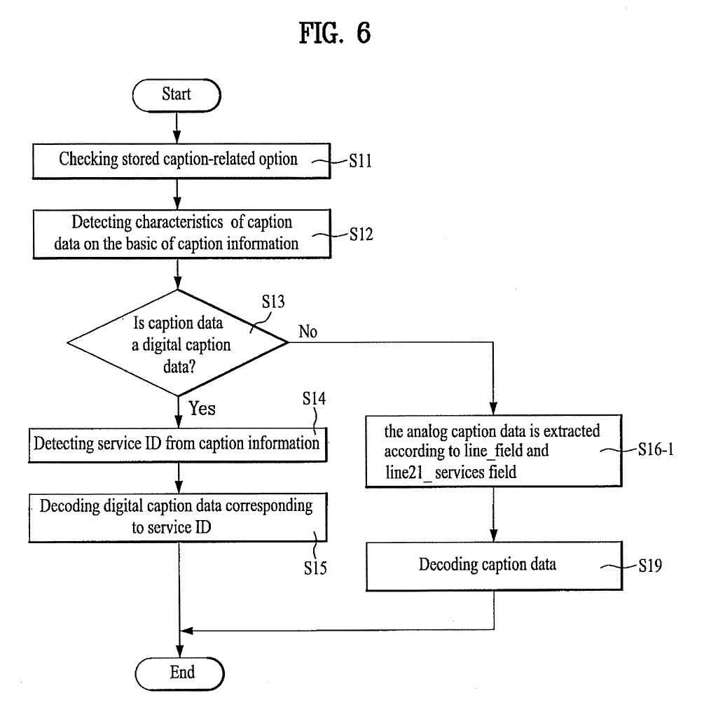

Operation of the digital broadcast receiver as described above according to the present invention will now be described. FIG. 4 illustrates a method for processing a caption according to the present invention.

If a MPEG-2 transport stream transmitted through a cable is received, the MPEG demultiplexer 501 divides the received transport stream into video data, and audio data, supplementary information. The supplementary information includes a PSIP defining electronic program guide (EPG) and system information (SI). The PSIP includes a plurality of tables including information for transmitting/receiving A/V (audio/video) data made in a MPEG-2 video and AC-3 (audio coding-3) audio formats, and information regarding channels of each broadcast station and information regarding each program of channel. Among them, information regarding the PMT and information regarding the EIT are stored in the PMT buffer 502 and the EIT buffer 503, respectively. Under the ATSC standard, the digital cable broadcast signal must include a caption_service_descriptor in its PMT or EIT.

The controller 504 reads a caption-related option stored in a memory (not shown) and determines a caption-related option selected by a user (S11). For example, the caption-related option includes various options such as “caption off”, “caption service selection (cc1, cc2, cc3, . . . )”, “English caption display”, “Korean caption display”, “size of caption”, “color of caption”. If a user selects “caption off”, the controller 504 does not display the received caption. If a user selects “English caption display”, the controller 504 controls the caption decoders 506 and 507 so that only the caption written in English may be displayed on a screen. Further, the controller 504 controls the caption decoders 506 and 507 so that the received caption data may be processed according to a set size and a set color of a caption.

The controller 504 receives the caption information and judges characteristics of the received caption data on the basis of parameter values included in the caption information (S12). The controller 504 judges a number of caption services on the basis of the caption information. For example, the controller 504 judges whether a synchronous caption, an asynchronous caption service, a letter information service are provided. The controller 504 judges a language of the received caption on the basis of the caption information. For example, the controller 504 judges whether the received caption is English, Japanese, or Korean. The controller 504 judges a type of the received caption data on the basis of the caption information. For example, the controller 504 judges whether the received caption data is digital caption data or analog caption data (S13). The controller 504 determines a standard of the received caption data on the basis of the caption information. For example, if the received caption data is analog caption data, the controller 504 judges whether the received caption data is caption data under the EIA 708 standard or the SCTE 20 or the DVS 157 standard. Further, the controller 504 judges a VBI line number and a field including the received caption, a difficulty level of the received caption, and a picture ratio of the received caption on the basis of the caption information.

To judge whether the received caption data is digital caption data in the step of S13, the controller 504 judges whether the digital caption data is included in the video data on the basis of the caption information.

If digital caption data under the EIA 708 is included in the video data (if cc_type==1), the controller 504 detects a service ID that corresponds to the caption data from the caption information (S14) and transmits the detected service ID to the digital caption decoder 507. The service ID can be known from a capto_service_number included in the caption information. The digital caption decoder 507 extracts and decodes caption data that corresponds to the service ID from user_data of a picture header transmitted from the video parser 505 (S15). Subsequently, the extracted caption data is transmitted to the video combiner 509. The video combiner 509 combines the extracted caption data, video data outputted from the MPEG-2 video decoder 508, and signals outputted from the graphic block 510.

If analog caption data is included in the video data (if cc_type==0), the controller 504 judges whether the received caption data is analog caption data (analog_cc_type==1) under the EIA 708 standard or analog caption data (analog_cc_type==0) under the SCTE 20 or DVS 157 standard (S16). At this point, the controller 504 determines a standard of the received analog caption data on the basis of the caption information.

If the received caption data is analog caption data under the SCTE 20 or the DVS 157, the controller 504 checks VBI line information described in 5 bits by a line_offset included in the caption information. The VBI line information represents a position of the caption data. Further, the controller 504 judges a field where the caption data exists on the basis of line_field information included in the caption information. If line_field==0, the caption data exists in an odd field and if line_field==1, the caption data exists in an even field. After that, the controller 504 transmits the above checked VBI line information and the line field information to the analog caption decoder 506. If the received caption data is analog caption data, user_data outputted from the video parser 505 is not processed by the digital caption decoder 507. The analog caption decoder 506 finds out (S18) analog caption data made in the SCTE 20 or the DVS 157 standard from user_data inputted from the video parser 505 on the basis of the VBI line information and the line field information, and decodes the analog caption data (S19). The analog caption data found by the analog caption decoder 506 is transmitted to the video combiner 509. The video combiner 509 combines the analog caption data, video data outputted from the MPEG-2 video decoder 508, and signals outputted from the graphic block 510. Signals outputted from the video combiner 509 are transmitted to the video reconstructor 511. The video reconstructor 511 reconstructs a caption by encoding analog caption data outputted from the analog caption decoder 506, at a VBI 21^{st} line. The reconstruction of a caption is to prevent analog caption data from being an open caption in case of storing data, as it is, outputted from the video combiner 509 in a storage medium such as a VCR (video cassette recorder).

If the received caption data is analog caption data under the EIA 708 standard (if analog_cc_type==1), the controller 504 transmits line_field information included in the caption information to the analog caption decoder 506. Since analog caption data under the EIA 708 standard is positioned at a VBI 21^{st} line, a line_offset value is not required. At this point, the digital caption decoder 507 extracts a 2-byte analog data in user_data including digital caption data from the video parser 505 and transmits the analog data to the analog caption decoder 506. Subsequently, the analog caption decoder 506 finds out (S17) analog caption data present in a VBI 21^{st} line from the 2-byte analog data on the basis of the line_field information and decodes the analog caption data (S19). The found analog caption data is combined with video data from the MPEG-2 video decoder 508 and signals from the graphic block 510 by the video combiner 509. The video reconstructor 511 reconstructs a caption by encoding analog caption data from the analog caption decoder 506 at a VBI 21^{st} line.

If analog caption data under the EIA 708 and analog caption data under the SCTE 20 and the DVS 157 are all present in the user_data, the analog caption data under the EIA 708 is processed. Further, if digital caption data under the EIA 708 and analog caption data under the EIA 708 are all present in the user_data, the digital caption data is processed.

As described above, the present invention judges a type of caption data on the basis of caption information included in the received broadcast signal and automatically processes the caption data according to the type, thereby providing convenience to a user. Further, the present invention judges various characteristics of the received caption data such as a standard of caption data, a number of caption services being received and provides the characteristics to a user. Furthermore, the present invention can store caption-related options selected by a user and display the caption being received according to the caption-related options.

As described above, caption services thorough line 21 closed caption in caption data includes CC1 (primary synchronous caption service), CC2 (special asynchronous caption service), CC3 (secondary synchronous caption service), CC4 (special asynchronous caption service), Text1 (first letter information service), Text2 (second letter information service), Text3 (third letter information service) and Text4 (fourth letter information service). These caption services are regulated under EIA 608 (Consumer Electronics Association (CEA)-708-B) and EIA 708 (CEA-708-B). Users, which receive a broadcast signal including these caption services can not display one among these caption service selectively, because the caption information (as information in a descriptor illustrated in FIG. 2) can not describe which caption service in user_data is included. Accordingly, when the users view a program through a digital broadcast receiver receiving a broadcast signal, the users have difficulty in selecting and displaying caption data corresponding to caption services

FIG. 5 is another example of a syntax of the caption_service_descriptor describing what kind of caption service is included in the received broadcast signal.

This caption_service_descriptor may be included in at least one of the PMT and the EIT out of the supplementary information. Specially, the caption_service_descriptor can be included in the EIT.

The fields “descriptor_tag”, “descriptor_length”, “reserved” and “number_of_service” are the same as those described in FIG. 2.

Also, field “language” defines the language associated with one caption service corresponding to “number_of_service”. Field “digital_cc” indicates whether the caption data is an digital television closed caption service or a line 21 closed caption service (an analog closed caption service). For example, when “digital_cc” is set, the field may indicate that an digital television closed caption service is present in user_data in accordance with CEA-708-B. And, when “digital_cc” is clear, the field may indicate that a line 21 closed caption service is present in user_data encapsulated per CEA-708-B.

If the digital television closed caption is included in user_data, “caption_service_number” identifies which digital caption service is included in the caption data. And, the caption_service_descriptor describes information according to “easy_reader” and “wide_aspect ratio”. Fields “easy_reader” and “wide_aspect_ratio” have already been described in FIG. 2.

Meanwhile, if the line 21 closed caption service is present in user_data, information according to fields “line21_services” (a) and “line_{—}21 field” (b) can be obtained.

Field “line21_services” (a) may has a 4-bit unsigned integer value. Each bit is associated with the line 21 service defined in CEA-708-B (CEA-608-B).

For, example, if the “digital_cc” flag indicates the line-21 close caption service and “line21_field” (b) indicates field 1, then each bit of “line21-services” may indicate at least one of CC1, CC2, Text1 and Text2 services.

For example, when the first bit of “line21_services” (bit 0 (0x1)) is set, the first bit indicates that the CC1 service is available. When clear, this bit indicates that the CC1 service is not available.

When the second bit of “line21_services” (bit 1 (0x2)) is set, the second bit indicates that the CC2 service is available. When clear, this bit indicates that the CC2 service is not available.

When the third bit of “line21_services” (bit 2 (0x4) is set, the third bit indicates that the Text1 service is available. When clear, this bit indicates that the Text1 service is not available.

And the fourth bit of “line21_services” (bit 3 (0x8)) is set, the fourth bit indicates that the Text2 service is available. When clear, this bit indicates that the Text2 service is not available.

Meanwhile, if the “digital_cc” flag indicates the line-21 close caption service and “line21_field” indicates field 2, then “line21_services” may indicate at least one of CC3, CC4, Text3 and Text4 services.

Just as the above example, what analog caption data is included in the caption data can be described in a bitmask method. Namely, when the first bit of “line21_services” is set, the first bit indicates that the CC3 service is available. And when clear, the first bit indicates that the CC3 service is not available.

When the second bit of “line21_services” (bit 1 (0x2)) is set, the second bit indicates that the CC4 service is available. When clear, this bit indicates that the CC4 service is not available.

When the third bit of “line21_services” (bit 2 (0x4)) is set, the third bit indicates that the Text3 service is available. When clear, this bit indicates that the Text3 service is not available.

When the fourth bit of “line21_services” (bit 3 (0x8)) is set, this bit indicates that the Text4 is available. When the fourth bit is clear, this bit indicates that the Text4 service is not available.

And “line21_field” indicates as follows: when “line21_field” is set, that the line 21 closed caption service is associated with the field 2 defined in CEA-608-B (CEA-708-B). And when this flag is clear, the line 21 closed caption service is associated field 1 defined in CEA-608-B (CEA-708-B). The “line21_field” flag is defined only if the “digital_cc” flag indicates the line-21 closed caption service. Accordingly, line 21_services and line_{—}21 field can describe at least one detailed closed caption services in the analog caption data.

According to this embodiment, the analog caption service can be described in the caption_service_descriptor in details. So a broadcast receiver can parse the analog caption data in the video data by the caption information in the caption_service_descriptor. And the broadcast receiver's user can select one caption service in the analog caption services through a user menu displayed by the graphic block. Then the broadcast receiver can provide the analog caption services according to the user's selection.

FIG. 6 illustrates another flowchart representing an embodiments of a method for processing caption data. Each of the steps in FIG. 6 is similar to the example in FIG. 4.

Using the caption information in the EIT (or the PMT) the caption data in video data is detected (S12). It can be determined whether the detected caption data is digital caption data or analog caption data on a basis of the “digital_cc” field in FIG. 5 (S13). If the caption data in the video data is digital caption data, the caption data can be proceeded in the manner described in FIG. 2 (S14 and S15).

If the caption data in the video data is analog caption data, it can be determined that the caption data is regulated under EIA 708. And the analog caption data can be extracted according to “line_field” and “line21_services” (S 16-1). The “line_field” flag indicates whether the caption service provided by the analog caption data is associated with the field 1 or field 2 defined in CEA 708-B (CEA 608-B). And field “line21_services” indicates what kind of the caption service is included in the analog caption data. Accordingly, the fields can identify what kind of the caption data service is provided by the caption data.

And the caption data is decoded on the basis of the two fields (S19).

Referring to the FIG. 3 again, when a broadcast receiver detects and extracts the analog caption data along with the fields, the broadcast receiver can provide the user with a menu where the user can select which caption service is provided. By the user's selection signal, the controller 504 sends a control signal according to the user's selection to the graphic block 510. And the graphic block 510 generates a user interface including the menu and sends the video combiner 509. The video combiner 509 combines images displayed by the decoded video data with the menu on screen. Then the menu including information on the line 21 closed caption data can be displayed. And the analog caption decoder decodes line 21 closed caption data according to the caption information in described in the FIG. 5.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A digital broadcast receiver comprising:
a demultiplexer configured to demultiplex received broadcasting signals into supplementary information stream including Event information table (EIT), audio stream and video stream;
a controller configured to detect caption information and detailed caption service information from the EIT;
a video decoder configured to decode video data from the video stream;
a digital caption decoder configured to decode digital caption data in the video stream according to the caption information; and
an analog caption decoder configured to decode analog caption data in the video stream according to the caption information and the detailed caption service information,
wherein the detailed caption service information indicates what kind of analog caption service is provided by decoding the analog caption data.

2. The digital broadcast receiver of claim 1, wherein the caption information and the detailed caption service information are included in the Program map table (PMT).

3. The digital broadcast receiver of claim 1, wherein the caption information indicates whether an digital television closed caption service is present in the video stream or an line 21 closed caption service is present.

4. The digital broadcast receiver of claim 1, wherein the detailed caption service information indicates that analog caption data is at least one of primary synchronous caption service, special asynchronous caption service, first letter information service, second letter information service, secondary synchronous caption service, special asynchronous caption service, third letter information service and fourth letter information service, all of which are regulated under Consumer Electronics Association (CEA)-708.

5. The digital broadcast receiver of claim 1, wherein the detailed caption service information include one bit of first field indicating “field 1” or “field 2” defined in Consumer Electronics Association (CEA)-708, and four bits of second field indicating that what kind of analog caption service is provided according to the first field.

6. The digital broadcast receiver of claim 5, wherein first bit of the four bits of the second field indicates whether primary synchronous caption service is provided or not, second bit of the four bits indicates whether special asynchronous caption service is provided or not, third bit of the four bits indicates whether first letter information service is provided or not, and fourth bit of the four bits indicates whether second letter information service is provided or not, respectively.

7. The digital broadcast receiver of claim 5, wherein first bit of the four bits of the second field indicates whether secondary synchronous caption service is provided or not, second bit of the four bits indicates whether special asynchronous caption service is provided or not, third bit of the four bits indicates whether third letter information service is provided or not and fourth bit of the four bits indicates whether fourth letter information service is provided or not, respectively.

8. A method for processing a digital broadcast signal, the method comprising:
demultiplexing a broadcast signal into supplementary information stream including Event information table (EIT), audio stream and video stream;
detecting caption information and detailed caption service information from the EIT; and
decoding analog caption data in the video stream according to the caption information and the detailed caption service information,
wherein the detailed caption service information indicates what kind of analog caption service is provided by decoding the analog caption data.

9. The method of claim 8, wherein the caption information and the detailed caption service information are included in the Program map table (PMT) in the supplementary information stream.

10. The method of claim 8, wherein the caption information indicates whether an digital television closed caption service is present or a line 21 closed caption service is present in the video stream.

11. The method of claim 8, wherein the detailed caption service information indicates that the analog caption data provides at least one of primary synchronous caption service, special asynchronous caption service, first letter information service, second letter information service, secondary synchronous caption service, special asynchronous caption service, third letter information service and fourth letter information service, all of which are regulated under Consumer Electronics Association (CEA)-708.

12. The method of claim 11, wherein the detailed caption service information include first field indicating “field 1” or “field 2” defined in Consumer Electronics Association (CEA)-708, and second field indicating that what kind of analog caption service is provided according to the first field.

13. The method of claim 12, wherein first bit of the four bits of the second field indicates whether the primary synchronous caption service is provided or not, second bit of the four bits indicates whether the special asynchronous caption service is provided or not, third bit of the four bits indicates whether the first letter information service is provided or not, and fourth bit of the four bits indicates whether the second letter information service is provided or not, respectively.

14. The method of claim 12, wherein first bit of the four bits of the second field indicates whether the secondary synchronous caption service is provided or not, second bit of the four bits indicates whether the special asynchronous caption service is provided or not, third bit of the four bits indicates whether the third letter information service is provided or not and fourth bit of the four bits indicates whether the fourth letter information service is provided or not, respectively.
